(19) United States
(12) Patent Application Publication
(10) Pub. No.: US 2012/0093978 A1
(43) Pub. Date: Apr. 19, 2012

(54) FOOD PRODUCTS WITH IMPROVED TASTE

(76) Inventors: Garmt Bernard Dijksterhuis, AT Vlaardingen (NL); Elodie Le Berre, AT Vlaardingen (NL); Andrew Thomas Woods, AT Vlaardingen (NL)

(21) Appl. No.: 13/379,739

(22) PCT Filed: Jun. 16, 2010
(86) PCT No.: PCT/EP2010/058460

§ 371 Date: Dec. 21, 2011

Related U.S. Application Data
(60) Provisional application No. 61/223,151, filed on Jul. 6, 2009.

(51) Int. Cl. A23L 1/237; A23L 1/304; A21D 13/08; A23L 1/39; A21D 13/00

(52) U.S. Cl. 426/2; 426/649; 426/533; 426/589; 426/549; 426/556; 426/648; 426/87

(57) ABSTRACT

The aim of the present invention is to prevent that food products, which have a decreased concentration of salt, which can be considered to be unhealthy when consumed in large amounts, from having negative taste attributes. The present invention provides such food products containing two sections, wherein the two sections are visually the same, and wherein the two sections contain a salty tastant at different concentrations in the two sections.

The present invention relates to food products containing two sections, wherein the two sections are visually the same, and wherein the two sections contain a salty tastant. The invention further relates to a product comprising said food product and instructions for consumption of that product. The invention further relates to a method for consumption of the said food product. The invention further relates to a method for reduction of saltiness of food products. The invention further relates to a method for production of said food products.

### BACKGROUND OF THE INVENTION

Food product manufacturers often wish to decrease the amount of some of the ingredients of their food products, without compromising on the taste and liking of the products. As an example, reduction of the salt (kitchen salt, sodium chloride) level of food products would be advantageous for the health of the consumer, as high sodium intake may increase blood pressure. Also sugar reduction would be advantageous, because sugar contributes to the caloric value of a food product, and possibly to obesity of the consumer. Replacing sugar by (artificial) sweeteners is often undesired, as these sweeteners may be perceived as unnatural by the consumer, or may contribute to an off-taste of the food product. Similarly replacing kitchen salt by alternatives likes potassium chloride may lead to off-taste of the food products, due to bitterness or metallic taste of potassium chloride.

Food products containing different sections with different concentrations of tastant are known. At the 9^{th} International Multisensory Research Forum (IMRF) in Hamburg, Germany, 16^{th} to 19^{th} July 2008, the present inventors presented a paper wherein it was disclosed that in spite of variations in food flavours over mouthfuls, we rarely acknowledge or even perceive such variations. The consumer experiences a contiguous food flavour despite obvious variation in sensory signals. A cookie model-food-stimulus was developed, with two sections, whose two halves sometimes differed in levels of sugar (0%, 33% and 67% sugar quantity differences) but were visually indistinguishable (to ensure the assumption of a contiguous cookie). When starting to eat the cookie at the half with the highest sugar concentration, followed by eating (in a next bite) the half with a lower sugar concentration, sweetness ratings for 0% and 33% cookie halves were indistinguishable, while the sweetness difference between the halves of the ‘67% cookie’ was observed. This effect can mask flavour variation, but whose effects seem to be modulated by increasing exposure to discrepant stimuli.

US 2007/0231430 A1 discloses candies containing different sections. These sections contain a different concentration of sour ingredients, leading to increasing sour intensity experience when eating the sections after each other. The eating of the candy is finished with an extinguisher section, in order to douse the sourness. When consuming this candy the consumer perceives a difference in taste between the various sections.

Solutions as proposed for reduction of sugar level in the prior art are not suitable to be used as such for decreasing the amount of salt. There are several key differences between sugar and salt sensation, perception and neuroscience to support this view.

Firstly, sugar and salt are encoded in the mouth via different mechanisms (S. D. Roper, 2007, Pflugers Archiv-European Journal of Physiology, 454, 759-776), the resulting activation relayed to the brain and innervating different neurons in the primary taste cortex (E. T. Rolls, 1989, Journal of Experimental Biology 146, 141-164). The mechanisms involved in the way each taste is experienced differ as they act on different populations of neurons.

Secondly, in terms of evolution, a sweet taste implies a food is energy rich and thus to be consumed; the sweeter the food, the more energy rich and thus more valuable to the individual. However, food saltiness does not behave in the same fashion. Whilst a small amount of salt acts as to enhance a food's flavour (e.g. M. Gillette, 1985, Food Technology 39, 47-52), increasing levels of salt can at first be unpleasant, and indeed may induce nausea and even vomiting. Thus, sugar can be seen to always be positive, whilst salt is both positive and negative. It is logical to be aware of the level of salt in a food to avoid any negative salt response from eating too salty food. Additional mechanisms must be in place to temper any effect of a potential homogeneous high salt concentration in light of potential negative affects from salt consumption.

Thirdly, as mentioned above, salt acts as a flavour enhancer, influencing the perception of many food cues. Sugared food on the other hand is only thought to taste sweet.

Thus, salt can be seen to influence food flavour on a holistic many-flavour level, sugar only influences sweetness. The mechanism shown in the prior art for sugar reduction acts only to smooth over variation for sweetness. For salt though, it must act in an orchestrated fashion across many food attributes, as salt influences the taste of other food components much more than sugar does. Additional mechanisms must coordinate this. There is neurological evidence to support a hierarchy distinction between a sugar effect (lower) and a salt effect (higher): whereas ‘base taste sensations’ (salt, sweet, umami) lead to activity in primary taste cortex, higher-order holistic taste representations (additional taste and flavours which may be enhanced by the presence of salt) only arise in the secondary taste cortex, one level up the neurological hierarchy of taste processing (E. T. Rolls, 2006, Philos Trans R Soc Lond B Biol Sci, 361, 1123-1136).

Finally the salt-receptor is extremely finicky, meaning it almost uniquely responds to NaCl and nothing much more. This makes is not an automatic inference that effects that are found for other tastes like sweetness or bitterness will be valid for saltiness too.

Concluding it cannot be assumed that what affects a liked stimulus like sugar will affect a stimulus like salt which may be disliked in high concentrations, and all these reasons make it more difficult to reduce salt than sugar.

### SUMMARY OF THE INVENTION

In spite of the solutions that have been proposed, there still is a need for food products which have a reduced content of ingredients which may be liked by the consumer but may be considered to be unhealthy when consumed in high quantities (like salt, here termed ‘unhealthy ingredients’), without compromising on taste of the food products which contain concentrations of ‘unhealthy’ ingredients in normal amounts. ‘Normal amounts’ should be understood to mean that the concentration of the tastant is what the consumer expects and likes.

Hence it is an object of the present invention to provide food products which have decreased concentration of ‘unhealthy’ ingredients, especially salt, without compromising on the taste, flavour, feeling, mouthfeel and liking of these products as compared to similar products which do not have the decreased level of ingredients.

We have now found that the concentration of ‘unhealthy’ ingredients in food products can be reduced (for example good tasting ingredients for which there may be a general desire to decrease the intake of these, like salt), while the consumer does not observe the decrease of the ‘unhealthy’ ingredients. The consumer perceives the food product of which the ‘unhealthy’ ingredient has been reduced to be homogeneous with regard to taste and of the same quality as food products with a normal concentration of the tastant. This is achieved by distributing the tastant across at least two sections in different concentrations, wherein the at least two sections have the same visual appearance (e.g. colour, structure, texture, or any other obviously and directly perceivable property without tasting or smelling), such that the at least two sections of the food product appear to be having the same composition and that the food product is a homogeneous composition. These at least two sections are consumed in different bites or different sips. Due to the homogeneous appearance of the food product, the consumer expects a constant tasting food product, and the consumer does not detect the decrease of the ‘unhealthy’ ingredient. During the consumption of the food product, for example when having consumed the first section, and starting with the second section, the consumer still perceives the food product to be homogeneous, as the visual appearance of the second section is the same as that of the first section.

In case a reduction of a tastant is desired (e.g. salt), the first section (which is taken in first when consuming the food product) contains a normal concentration of the tastant, while the second section (which is consumed directly after finishing the first section) contains a lower concentration of the tastant. In general terms, if the sections would be eaten as single sections (not as part of a coherent food product comprising both sections), the consumer will like the first section more than the second section. That is because the first section contains a normal concentration (which means an amount that the consumer expects) of the tastant, for example in case of salt the saltiness of the first section is as the consumer likes it and expects it. The second section though contains a lower concentration of the tastant, and again in case of salt, the saltiness of the second section is lower than of the first section, and generally lower than the consumer would prefer.

Due to the homogeneous visual appearance, the consumer expects a homogeneously tasting product, and will indeed experience this when consuming the food product. The concentration difference of the tastant between the two sections is not observed, and consequently the amount of salt can be decreased, without the consumer noticing this. This may have beneficial health effects for the consumer.

Accordingly in a first aspect the present invention provides a food product containing two sections, wherein the two sections are visually the same, wherein the two sections contain a salty tastant at different concentrations in the two sections, wherein the ratio of concentrations of the salty tastant in the first section and second section is between from 20:1 to 1.1:1 based on weight of the tastant, wherein the two sections are consumable in discrete portions, and wherein the volume of each of the two sections is equal to or larger than a natural single bite or single sip.

The food product comprises a salty tastant and the second section contains a lower concentration of that tastant than the first section. In a second aspect the invention provides a product comprising said food product, and instructions for consumption of the food product, wherein the instructions define that the first section having the higher concentration of tastant should be consumed first, immediately followed by consumption of the second section having the lower concentration of tastant.

In a third aspect the invention provides a method for consumption of the said food product, wherein the first section having the higher concentration of tastant is consumed first, immediately followed by consumption of the second section having the lower concentration of tastant.

In the preferred case of the food product wherein the second section contains a higher concentration of that tastant than the first section, then alternatively in a third aspect the invention provides a method for consumption of the said food product, wherein the first section having the lower concentration of tastant is consumed first, immediately followed by consumption of the second section having the higher concentration of tastant.

In a fourth aspect the invention provides a method to increase the perceived saltiness of food products, by consuming a food product according to the first aspect of the invention.

And finally in a fifth aspect the present invention provides a method for the production of a food product comprising a salty tastant, wherein the prepared food product contains two sections,

wherein the two sections are visually the same, wherein the two sections contain a salty tastant at different concentrations in the two sections, comprising the steps of:
preparing a first mixture of food ingredients comprising the salty tastant to form a first section;
preparing a second mixture of food ingredients comprising the salty tastant at a different concentration to form a second section,
combining the two mixtures and preparing the food product,
   and wherein the ratio of concentrations of the salty tastant in the first section and second section is between from 20:1 to 1.1:1 based on weight of the salty tastant, wherein the two sections are consumable in discrete portions,
   and wherein the volume of each of the two sections is equal to or larger than a natural single bite or single sip.

### DETAILED DESCRIPTION

Unless defined otherwise, all technical and scientific terms used herein have the same meaning as commonly understood by one of ordinary skill in the art.

The term ‘unhealthy ingredients’ should be understood to relate to ingredients which are not unhealthy as such, and they may also be ingredients which are consumed on a day to day basis as part of the normal diet. Such ingredients may become unhealthy for individual consumers when consumed in high quantities, wherein ‘high’ depends on the individual consumer and the specific diet of that consumer. Thus ‘high’ for one consumer may be a correct amount for another consumer. An example of such an ingredient is salt (kitchen salt, sodium chloride), as a high sodium intake may lead to increased blood pressure. Another example is sugar, as sugar contributes to the caloric value of a food product, and therewith possibly to obesity of the consumer if that consumer takes in more calories than used when being active or by the metabolism.

The term ‘healthy ingredients’ should be understood to relate to ingredients which are considered to be healthy when consumed, however usually these are not yet part of the normal diet, or if they are part of the diet, they are consumed in too low amounts to be effective for health of the individual consumer. If consumed in quantities which may lead to a beneficial health effect, these ingredients may contribute to negative taste attributes which are not generally liked by consumers. Examples are bitter compounds, like the methylxanthines or polyphenolic compounds from grape, wine, or olives.

All percentages, unless otherwise stated, refer to the percentage by weight. The term ‘wt %’ refers to the percentage by weight.

Preferred aspects disclosed in connection with the first, or second, or third, or fourth or fifth aspect of the present invention, may also be applicable to the other aspects of the present invention, mutatis mutandis. The various features and embodiments of the present invention, referred to in individual paragraphs above apply, as appropriate, to other paragraphs, mutatis mutandis. Consequently features specified in one paragraphs may be combined with features specified in other paragraphs, as appropriate. All publications mentioned in the specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the claims.

### Food Products

In a first aspect the present invention provides a food product containing two sections, wherein the two sections are visually the same, wherein the two sections contain a salty tastant at different concentrations in the two sections, wherein the ratio of concentrations of the salty tastant in the first section and second section is between from 20:1 to 1.1:1 based on weight of the tastant, wherein the two sections are consumable in discrete portions, and wherein the volume of each of the two sections is equal to or larger than a natural single bite or single sip.

The food product according to the invention contains at least two sections, wherein the two sections are visually the same. The phrase ‘visually the same’ is understood to mean that the at least two sections have the same visual appearance, which relates to the colour, structure, texture, or any other obviously and directly perceivable property without tasting or smelling, such that the at least two sections of the food product appear to be having the same composition for the observer of the food product.

The two sections are consumable in discrete portions, which is understood to mean that the portions are consumed in different bites or different sips, and wherein the discrete portions have a size which is a normal average single bite or single sip size for the specific food product. The volume of the at least two sections is equal to or larger than a natural single bite or single sip. For example the first section may be consumed in 1, 2, 3, 4, 5, 6, 7, 8, 9, or 10 natural bites or natural sips. This means that for various food products the two sections may have different natural sizes. If the food product is a bread or a nutritional bar, then the natural single bite size may be larger than when the food product is an ice cream. If the preferred food product is an ice cream, then the volume of the first section will be at least the size of one natural bite. The volume of the first section may also be the size of two or three or more natural bites.

Preferably the food product according to the invention is a food product wherein the second section has a volume maximally equal to the first section. In that case the consumer will consume the second section with a clear memory of the first section, and will remember the good tasting first section. For example the volume of the second section may be the same as the volume of the first section, or it may be half the volume of the first section, or it may be a quarter of the first section, or any other volume smaller than the first section. The volume of the second section is equal to or larger than a natural single bite or single sip. For example the first section may be consumed in 1, 2, 3, 4, or 5 natural bites or natural sips.

Preferably, the first aspect of the invention provides a food product, wherein the food product is solid or semi-solid. A solid or semi-solid food product is understood to mean a product which has a solid or semi-solid appearance. This may include food product which partly contain liquid or soft ingredients or elements and partly contain solid ingredients. Examples of such products include but are not limited to bread, ice cream, chocolate, candy bars, and nutritional bars. Preferably the food product is designed such that the two sections are arranged in linear fashion, thus next to each other. In linear fashion may also be understood that the food product is curved. Alternatively the second section may be a core surrounded by the first section. Alternative layouts may be suitable as well.

Preferably the food product is a product wherein the two sections are in contact with each other, which is understood to mean that the two sections may be affixed to each other as a continuous product, for example in a nutritional bar wherein the two sections may form a homogeneous food product which seemingly does not contain discrete sections. This way the preferred food product according to the invention is considered to be a food product having a homogeneous composition, and does not appear to be a product having sections with a different concentration of the tastant over the various sections.

The food product may be a beverage or other liquid product (like soup), in which case the food product is packed in packaging material in which the sections are divided over different compartments. When the liquid food product is consumed from the packaging material directly, then the design is such that the first section is consumed first, followed by consumption of the second section.

The sections of the food product contain the same tastant, at a different concentration though. This is understood to mean that the tastant is distributed as homogeneous as possible in the sections of the food product (natural little variations can be neglected). The concentration of the tastant in each section should be considered across the section as a whole. There may be tiny spots in the section which contain locally a higher or lower concentration of the tastant, due to natural variations, or due to the composition of the section. For example the section may contain chunks of an ingredient (for example pieces of chocolate in the bulk of an ice cream), and inside these chunks the local concentration of the tastant may be higher or lower than seen on the scale of the section as a whole. The concentration of the tastant between the sections is not the same: the ratio of concentrations of the tastant in the first section and second section is between from 20:1 to 1.1:1 based on weight of the tastant.

The concentration of the tastant in the first section is higher than in the second section. The concentration in the first section is from 1.1 to 20 times as high as in the second section, based on the weight of the tastant. Natural variations in the concentration of a tastant in a product, which are undesired and unplanned in designing and manufacturing the product and which may be due to natural variations, or due to incomplete mixing, are considered to be outside the scope of this invention.

Preferably the food product according to the invention is a food product, wherein the ratio of concentrations of the tastant in the first section and second section is between from 15:1 to 1.2:1, preferably between from 10:1 to 1.3:1; preferably between from 5:1 to 1.4:1; preferably between from 3:1 to 1.5:1; based on the weight of the tastant.

Alternatively, the ratio of concentrations of the tastant in the first section and second section is preferably between from 3:1 to 1.1:1, preferably between from 2.5:1 to 1.2:1, preferably between from 2:1 to 1.3:1; preferably between from 1.8:1 to 1.4:1; preferably between from 1.6:1 to 1.5:1.

Preferably the food product may contain more than two sections, and the concentration of the tastant in possible third, fourth or other sections will be adapted to the concentration in the first and second sections. Hence preferably the food product according to the invention is a food product additionally containing a third section, wherein the three sections are visually the same, wherein the ratio of concentrations of the salty tastant in the first section and third section is between from 5:1 and 1:5 based on weight of the tastant, wherein the concentration of the salty tastant in the third section is higher than in the second section, wherein the three sections are consumable in discrete portions, and wherein the volume of each of the three sections is equal to or larger than a natural single bite or single sip. More preferably the ratio of concentrations of the salty tastant in the first section and third section is between from 3:1 and 1:3, more preferred between from 2:1 and 1:2, more preferred between from 1.5:1 and 1:1.5, most preferred between from 1.1:1 and 1:1.1. The concentration of the tastant in the third section is most preferably similar to the concentration of the tastant in the first section, small natural variations (which are part of a common food manufacturing process) excluded.

In case the concentration of the tastant in the optional third section is lower than that in the first section, while still higher than in the second section, preferably the ratio of concentrations of the tastant in the first section and third section is between from 5:1 and 1.1:1 based on weight of the tastant, preferably between from 3:1 and 1.1:1, more preferred between from 2:1 and 1.1:1, most preferred between from 1.5:1 and 1.1:1.

In case the concentration of the tastant in the optional third section is higher than that in the first section, and also higher than in the second section, then preferably the ratio of concentrations of the tastant in the first section and third section is between from 1:1.1 and 1:5 based on weight of the tastant, preferably between from 1:1.1 and 1:3, more preferred between from 1:1.1 and 1:2, most preferred between from 1:1.1 and 1:1.5.

By this layered structure consequently the salt level in a food product can be decreased order to obtain a product which is perceived to be as salty as a comparative product wherein salt is homogeneously distributed. By a first bite the taste is adapted to a relatively high salt level, followed by a bite with a lower level which does not seem to be observed. An optional third bite then ‘rinses’ the lower salt level which may have been brought about by the second section. The amount of salt taken in (which is considered to be unhealthy when consumed in large amounts) can be reduced in this way.

Preferably the optional third section is in contact with the second section and not with the first section. This may be understood to mean that the three sections of the food product are arranged in a linear fashion, wherein the second section is located between the first and third sections. ‘In linear fashion’ may also be understood that the food product is not straight, but may be curved. Alternatively the third section forms a core, surrounded by a shell of the second section, which again is covered by a shell of the first section. The three sections together appear to form a homogeneous food product, wherein no concentration difference of the tastant seems to occur. Preferably the volume of the third section is about equal to the volume of the first section. Alternatively the volume of the third section is smaller than the volume of the first section, or it is larger than the volume of first section. The volume of the optional third section is equal to or larger than a natural single bite or single sip. For example the third section may be consumed in 1, 2, 3, 4, 5, 6, 7, 8, 9, or 10 natural bites or natural sips.

When consuming a preferred food product according to the invention having three discrete sections, usually the consumer starts with the first section having a normal concentration of the tastant, followed by eating the second section in a next bite having a decreased concentration of the tastant. Subsequently the third section is consumed, again preferably having a normal concentration of the tastant. Hence the consumer ends the consumption of the section of the food product that has a normal concentration of the tastant, which is the concentration of the tastant that the consumer likes. Therefore the impression that the consumer gets from consumption of this product is that the product is homogeneous, and the section having an increased or decreased concentration of the tastant is not observed.

Preferably, an optional third section again contains a concentration of the tastant similar to the first section. A preferred food product according to the invention additionally may contain a fourth section in addition to the three sections, wherein the four sections are visually the same,

wherein the ratio of concentrations of the tastant in the second section and fourth section is between from 1.1:1 and 1:1.1 based on weight of the tastant,
wherein the four sections are consumable in discrete portions,
and wherein the volume of each of the four sections is equal to or larger than a natural single bite or single sip. The concentration of the tastant in the fourth section is similar to the concentration of the tastant in the second section, small natural variations (which are part of a common food manufacturing process) excluded. Preferably the optional fourth section is in contact with the third section and not with the first or second section. This may be understood to mean that the four sections of the food product are arranged in a linear fashion, wherein the second and third sections are located inbetween the first and fourth sections. ‘In linear fashion’ may also be understood that the food product is not straight but curved. Alternatively the fourth section forms a core, surrounded by a shell of the third section, which again is covered by a shell of the second section, which again is covered by a shell of the first section. The four sections together appear to form a homogeneous food product, wherein no concentration difference of the tastant seems to occur. Preferably the volume of the fourth section is about equal to the volume of the second section. Alternatively the volume of the fourth section is smaller than the volume of the first section, or it is larger than the volume of first section. The volume of the optional fourth section is larger than a natural single bite or single sip. For example the fourth section may be consumed in 1, 2, 3, 4, or 5, natural bites or natural sips.

An optional fifth section is similar to the optional third section, mutatis mutandis. An optional sixth section is similar to the optional fourth section, mutatis mutandis. The food product also may contain more sections, as applicable.

The food product according to the invention contains a salty tastant,and preferably the salty tastant is kitchen salt (sodium chloride). For this salty tastant the concentration of the tastant in the first section is higher than the concentration of the tastant in the second section. In that case the amount of salty tastant can be reduced as compared to a conventional food product. A preferred food product according to the invention then is chosen from the group consisting of soup, bread, baked dough products, baked pastry products, nutritional bars, meat-based snacks like sausages, and cheese based snacks.

The food products according to the invention may contain a sweet tastant, or a sour tastant, or an umami tastant, or a bitter tastant, or a combination of two or more of these tastants, in addition to the salty tastant. If in a preferred embodiment the food production comprises a combination of tastants within the context of the invention, then the first tastant may be reduced in the second section as compared to the first section (e.g. sugar as a sweet tastant), and the second tastant may be increased in the second section as compared to the first section (e.g. theobromine as a bitter tastant). It may also be the case that the food product comprises two tastants which both have a decreased concentration in the second section, as compared to the first section. Or alternatively the other way around: tastants which both have an increased concentration in the second section, as compared to the first section.

Generally in case of ‘healthy ingredients’ the concentration of such a compound will be higher in the second section as compared to the first section and the optional third section. For example this may be the case for bitter compounds which may have a beneficial health effect.

Generally in case of ‘unhealthy ingredients’ the concentration of such a compound will be lower in the second section as compared to the first section and the optional third section. For example this may be the case for salty or sweet compounds which may not be beneficial for health if consumed in too high amounts.

In case the additional tastant is a sweet tastant, the tastant preferably is sugar (sucrose). The first and optional third sections of a preferred food product contain a normal amount of sugar, while the second section contains a lower amount of sugar.

Another preferred food product according to the invention, is a food product, wherein the additional tastant is a bitter tasting compound. In that case the concentration of the bitter tastant in the first section is lower than the concentration of the tastant in the second section.

Different additional tastants may have different preferred concentration ranges between the sections. For example if the tastant is a sweet tasting compound, the ratio of the concentration of the tastant between the first section and the second section is preferably between from 5:1 to 1.1:1; preferably between from 4:1 to 1.1:1; preferably between from 3:1 to 1.1:1, preferably between from 2.5:1 to 1.2:1, preferably between from 2:1 to 1.3:1; preferably between from 1.8:1 to 1.4:1; preferably between from 1.6:1 to 1.5:1.

When the food product according to the invention comprises an optional third section, then the ratio of concentrations of the optional additional sweet tastant in the first section and third section is preferably between from 3:1 and 1:3 based on weight of the tastant, wherein the concentration of the sweet tastant in the third section is higher than in the second section. More preferably the ratio of optional additional sweet salty tastant in the first section and third section is between from 2:1 and 1:2, more preferred between from 1.5:1 and 1:1.5, most preferred between from 1.1:1 and 1:1.1. The concentration of the optional additional sweet tastant in the third section is most preferably similar to the concentration of the tastant in the first section, small natural variations (which are part of a common food manufacturing process) excluded.

If the additional tastant is a bitter tasting compound, the ratio of the concentrations of the bitter tastant in the first section and second section is between from 1:1.1 to 1:20 based on weight of the tastant, preferably between from 1:1.2 to 1:15, preferably between from 1:1.3 to 1:10; preferably between from 1:1.4 to 1:5; preferably between from 1:1.5 to 1:3.

When the food product according to the invention comprises an optional third section, then the ratio of concentrations of the optional additional bitter tasting compound in the first section and third section is preferably between from 3:1 and 1:3 based on weight of the tastant, wherein the concentration of the bitter tasting compound in the third section is higher than in the second section. More preferably the ratio of optional additional bitter tasting compound in the first section and third section is between from 2:1 and 1:2, more preferred between from 1.5:1 and 1:1.5, most preferred between from 1.1:1 and 1:1.1. The concentration of the optional additional bitter tasting compound in the third section is most preferably similar to the concentration of the tastant in the first section, small natural variations (which are part of a common food manufacturing process) excluded.

In a preferred embodiment, the food product according to the invention comprises an additional tastant which is a bitter tasting compound, and wherein the tastant comprises a methylxanthine. Preferably the methylxanthine is chosen from one or more of the group consisting of caffeine, theobromine, theophylline, paraxanthine, and isocaffeine. Preferably the food products according to the present invention comprise a total amount of from 100 to 3,000 milligram of methylxanthines per unit amount of the food product. Preferably the methylxanthine is chosen from one or more of the group consisting of caffeine, theobromine, theophylline, and paraxanthine. Preferably the food products according to the invention comprise at least 200 mg, more preferably at least 300 mg methylxanthines per unit amount of the food product.

More preferably the food product according to the invention comprises an additional tastant, wherein the tastant comprises theobromine or caffeine or a mixture of these. Preferably the food product according to the invention comprises caffeine in an amount from 20 to 500 milligram per unit amount of the food product, more preferably comprises caffeine in an amount from 50 to 200 milligram, most preferably from 70 to 150 milligram per unit amount of the food product.

Another preferred food product according to the invention, comprises theobromine in an amount from 80 to 2,980 milligram per unit amount of the food product. More preferred the food product according to the invention comprises theobromine in an amount from 250 to 1,200 milligram per unit amount of the food product, even more preferred in an amount of 300 to 1,000 milligram, more preferably from 400 to 800 milligram, and mostly preferred from 600 to 800 milligram per unit amount of the food product.

These ranges as separately indicated for the preferred methylxanthines caffeine and theobromine may be combined in a single food product.

A preferred food product of the present invention is a food product that comprises caffeine in an amount from 20 to 500 milligram and theobromine in an amount from 80 to 2,980 milligram per unit amount of the food product. More preferred a food product according to the present invention comprises from 30 to 300 milligram caffeine and from 200 to 1,200 milligram theobromine per unit amount of the food product. Most preferred a food product according to the present invention comprises from 40 to 200 milligram caffeine and from 300 to 1,000 milligram theobromine per unit amount of the food product.

A unit amount of a food product is a quantity of a food product which is usually consumed as a single serving. The unit amount or serving size of such food products depends on the specific product. A few non-limiting examples of typical serving sizes are:
milk, yoghurt: 200 mL
natural cheese: 43 gram
processed cheese: 57 gram
fruit juice: 177 mL
soft drink: 200 mL
bread: 1 slice, 35 gram
coffee: 125 mL
tea: 150 mL
cereal bar, candy bar: 50 gram
chocolate: 30 gram
ice cream: 100 mL
spread: 15 gram
soup: 250 mL
cocoa beverage: 200 mL

A unit amount of a food product in the context of the present invention may be packed and sold as a single portion. The actual weight or volume of such an individually packed product may be higher or lower than indicated above for a standard serving size.

The food product may be dried and contain less than 40% water by weight of the composition, preferably less than 25%, more preferably from 1 to 15%. Alternatively, the food may be substantially aqueous and contain at least 40% water by weight of the composition, preferably at least 50%, more preferably from 65 to 99.9%.

The food product preferably comprises nutrients including carbohydrate (including sugars and/or starches), protein, fat, vitamins, minerals, phytonutrients (including terpenes, phenolic compounds, organosulfides or a mixture thereof) or mixtures thereof. The food may be low calorie (e.g. have an energy content of less than 100 kCal per 100 g of the composition) or may have a high calorie content (e.g. have an energy content of more than 100 kCal per 100 g of the composition, preferably between 150 and 1,000 kCal). The food may also contain flavours, colours, preservatives, antioxidants, non-nutritive sweetener or a mixture thereof.

### Instructions for Consumption of the Food Product and Method for Consumption of the Food Product

The food product comprises a tastant which is a salty tasting compound, and the second section contains a lower concentration of that tastant than the first section and an optional third section (and mutatis mutandis more sections having the corresponding concentrations might be included). In a second aspect the invention then provides a product comprising said food product, and instructions for consumption of the food product, wherein the instructions define that the first section having the higher concentration of tastant should be consumed first, immediately followed by consumption of the second section having the lower concentration of tastant, and optionally immediately followed by consumption of the third section having the higher concentration of tastant. Optional further sections are preferably consumed subsequently. The instructions may be printed on the pack in which an individual item or multiple items of the food product according to the invention is packed. Alternatively the instructions are supplied as a separate item within the package of the food product.

Alternatively the instructions may be implicit, in the sense that the product has been designed in such a way as to leaving the consumer no choice than eating the product section by section.

In case of the said preferred food product wherein the second section contains a lower concentration of that tastant than the first section and an optional third section (and mutatis mutandis more sections having the corresponding concentrations might be included), then in a third aspect the invention provides a method for consumption of the said preferred food product wherein the first section having the higher concentration of tastant is consumed first, immediately followed by consumption of the second section having the lower concentration of tastant, and optionally immediately followed by consumption of the third section having the higher concentration of tastant. Optional further sections are preferably consumed subsequently. The method for consumption of the food product may be followed by the consumer by adhering to the earlier described instruction. Alternatively the design of the food product may be such that the consumer automatically is directed to consuming the first section first, followed by the second section, and followed by an optional third section. For example, in case of an ice cream which is at the base affixed to a wooden stick, the first section is the top of the ice cream which is eaten firstly, and the second section is then eaten after finishing the first section. An optional third section is then eaten as the last section. Also the package design and way of opening the package may lead the consumer to eating the first section first, followed by the second section and optional further sections.

In case the food product comprises a tastant which is a salty tasting compound, and the second section contains a lower concentration of that tastant than the first section and an optional third section (and mutatis mutandis more sections having the corresponding concentrations might be included). By the method for consumption of the said product according to the third aspect of the invention, the concentration of the salty tasting compound can be reduced, without compromising on the quality of the food product. The consumer will not notice the difference in concentration of the sweet compound. Hence the present invention also provides a method for reduction of the concentration of a salty tastant, by consuming said preferred food product. In spite of a relative low concentration of the salty tastant in the second section (and optional further sections), the food product is not considered to taste less salty, according to the consumer who eats that food product.

Hence in a fourth aspect the invention provides a method to increase the perceived saltiness of food products, by consuming a food product according to the first aspect of the invention.

### Production of the Food Products

In a fifth aspect the present invention provides a method for the production of a food product comprising a salty tastant, wherein the prepared food product contains two sections,

wherein the two sections are visually the same,
wherein the two sections contain a salty tastant at different concentrations in the two sections,
comprising the steps of:
preparing a first mixture of food ingredients comprising the salty tastant to form a first section;
preparing a second mixture of food ingredients comprising the salty tastant at a different concentration to form a second section,
combining the two mixtures and preparing the food product,
   and wherein the ratio of concentrations of the salty tastant in the first section and second section is between from 20:1 to 1.1:1 based on weight of the tastant,
   wherein the two sections are consumable in discrete portions,
   and wherein the volume of each of the two sections is equal to or larger than a natural single bite or single sip.

Preferably the method according to the fifth aspect of the invention for the production of a food product comprising a salty tastant, wherein the prepared food product contains a third section containing a salty tastant, comprises the additional step of

preparing a third mixture of food ingredients comprising the salty tastant to form a third section, and combining the third section with the first section and the second section and preparing the food product,
and wherein the ratio of concentrations of the salty tastant in the first section and third section is between from 5:1 and 1:5 based on the weight of the tastant, wherein the concentration of the salty tastant in the third section is higher than in the second section, wherein the three sections are consumable in discrete portions,
and wherein the volume of each of the three sections is equal to or larger than a natural single bite or single sip.

Preferred aspects disclosed in connection with the first aspect of the present invention, may also be applicable to the fourth aspect of the present invention, mutatis mutandis.

The method for production depends on the actual food product according to the invention. For example if the food product is a bakery product, the preparation method generally involves a baking step. Or another example if the food product is a sausage, then the preparation method may involve a cooking or frying step.

### EXAMPLES

The following non-limiting example illustrates the present invention.

Sandwiches with Brunch Spread with Different Salt Levels

Two different sandwiches with a water-continuous spread were prepared, wherein the difference consisted in the distribution of salt in various sections of the sandwich. The sandwiches were rectangular shaped, having dimensions of about 8 cm length by 2 cm width by 1.5 cm thickness. The weight of 1 sandwich was about 20 gram.

The water-continuous spread used was the commercial product Brunch Légère 15% fat (Unilever Germany). The salt (NaCl) level of this product was 0.4%. Salt was added to part of the spread to reach a desired concentration, by manually mixing in table salt (NaCl). The bread was a white bread, with a salt level of 1.67%. Hence each section contained at least 1.67+0.4=2.07% salt (originating from bread and spread). Half of a slice of white bread was used to make 1 sandwich (bottom and top of the sandwich, and a layer of spread in between). The quantity of Brunch spread per sandwich was 4.5 grams (3 parts×1.5 g of Brunch per part).

The sandwiches according to the invention consisted of three sections, each having about equal volume. The volume of the sections were designed such that each section was consumed in one bite, thus the entire sandwich was consumed in three bites. The sections differed in the salt content of the spread. These three sections had the same visual appearance, such that the sandwich appeared to be of homogeneous composition.

The layout of the two sandwiches and the salt concentration in the various sections has been schematically indicated in the following table.

TABLE 1
Schematic layout and salt concentrations in the individual
sections of the two sandwiches.

| | | sandwich B |
|---|---|---|
| | sandwich A | (according to the |
| | (comparative) | invention) |
| | ‘homogeneous’ | ‘layered’ |
| section 1 (outer) | 2.4% | 2.77% |
| salt conc. [wt %] in | (0.33% added to spread) | (0.7% added to spread) |
| section | | |
| section 2 (middle) | 2.4% | 2.07% |
| salt conc. [wt %] in | (0.33% added to spread) | (0% added to spread) |
| section | | |
| section 3 (outer), | 2.4% | 2.37% |
| salt conc. [wt %] in | (0.33% added to spread) | (0.3% added to spread) |
| section | | |
| average salt conc. | 2.4% | 2.4% |
| per sandwich [g] | (0.33% added to spread) | (0.33% added to spread) |
| | 0.48 g salt per sandwich | 0.48 g salt per sandwich |

11 trained panellists performed a test on the 2 sandwiches. They were asked to eat each product of the pair in 3 equal bites starting with section 1, followed by section 2, and then section 3, to swallow between each bite and to rinse with water between each sandwich. They were not aware which product was sandwich A and which sandwich B. Once they had eaten the two sandwiches, they were asked to determine which one was more salty. Each panellist replicated the test 4 times, resulting in a total number of comparisons of 44.

The result was that out of 44 tests, 30 tests indicated that sandwich B (invention) was considered to be more salty, and 14 tests indicated that sandwich A (comparative) was considered to be more salty. This is a proportion of 68.1% that considered the sandwich of the invention to be more salty.

This result shows that the panellists perceived the layered sandwich as significantly more salty (p=0.0226). This can be attributed to the layered composition of the sandwich, as the total salt concentration of both sandwiches is equal. This result shows that consequently the salt level in a food product can be decreased by layering in order to obtain a product which is perceived to be as salty as a comparative product wherein salt is homogeneously distributed. By a first bite the taste is adapted to a relatively high salt level, followed by a bite with a lower level which does not seem to be observed. An optional third bite then ‘rinses’ the lower salt level. The amount of salt taken in (which is considered to be unhealthy when consumed in large amounts) can be reduced in this way.

1. A food product containing two sections,
wherein the two sections are visually the same,
wherein the two sections contain a salty tastant at different concentrations in the two sections,
wherein the ratio of concentrations of the salty tastant in the first section and second section is between from 20:1 to 1.1:1 based on weight of the tastant,
wherein the two sections are consumable in discrete portions,
and wherein the volume of each of the two sections is equal to or larger than a natural single bite or single sip.

2. A food product according to claim 1, wherein the second section has a volume maximally equal to the first section.

3. A food product according to claim 1, wherein the food product is solid or semi-solid.

4. A food product according to claim 1, wherein the two sections are in contact with each other.

5. A food product according to any of claims 1 to 4 claim 1, wherein the ratio of concentrations of the tastant in the first section and second section is between from 15:1 to 1.2:1, based on the weight of the tastant.

6. A food product according to claim 1, additionally containing a third section,
wherein the three sections are visually the same,
wherein the ratio of concentrations of the salty tastant in the first section and third section is between from 5:1 and 1:5, based on weight of the tastant,
wherein the concentration of the salty tastant in the third section is higher than in the second section,
wherein the three sections are consumable in discrete portions,
and wherein the volume of each of the three sections is equal to or larger than a natural single bite or single sip.

7. A food product according to claim 6, wherein the third section is in contact with the second section and not with the first section.

8. A food product according to claim 1, wherein the food product contains a sweet tastant, or a sour tastant, or an umami tastant, or a bitter tastant, or a combination of two or more of these tastants.

9. A food product according to claim 1, wherein the tastant is kitchen salt, and the food product is chosen from the group consisting of soup, bread, baked dough products, baked pastry products, and nutritional bars.

10. A product comprising a food product according to claim 1, and instructions for consumption of the food product,
wherein the instructions define that the first section having the higher concentration of tastant should be consumed first,
immediately followed by consumption of the second section having the lower concentration of tastant,
and optionally immediately followed by consumption of the third section having the higher concentration of tastant.

11. A method for consumption of the food product according to claim 1, wherein the first section having the higher concentration of tastant is consumed first, immediately followed by consumption of the second section having the lower concentration of tastant,
and optionally immediately followed by consumption of the third section having the higher concentration of tastant.

12. A method to increase the perceived saltiness of food products, by consuming a food product according to claim 1.

13. A method for the production of a food product comprising a salty tastant, wherein the prepared food product contains two sections,
wherein the two sections are visually the same,
wherein the two sections contain a salty tastant at different concentrations in the two sections,
comprising the steps of:
preparing a first mixture of food ingredients comprising the salty tastant to form a first section;
preparing a second mixture of food ingredients comprising the salty tastant at a different concentration to form a second section,
combining the two mixtures and preparing the food product,
and wherein the ratio of concentrations of the salty tastant in the first section and second section is between from 20:1 to 1.1:1 based on weight of the tastant,
wherein the two sections are consumable in discrete portions,
and wherein the volume of each of the two sections is equal to or larger than a natural single bite or single sip.

14. A method according to claim 13, for the production of a food product comprising a salty tastant, wherein the prepared food product contains a third section containing a salty tastant, comprising the additional step of
preparing a third mixture of food ingredients comprising the salty tastant to form a third section, and combining the third section with the first section and the second section and preparing the food product,
and wherein the ratio of concentrations of the salty tastant in the first section and third section is between from 5:1 and 1:5 based on the weight of the tastant, wherein the concentration of the salty tastant in the third section is higher than in the second section, wherein the three sections are consumable in discrete portions,
and wherein the volume of each of the three sections is equal to or larger than a natural single bite or single sip.
